(19) United States
(12) Patent Application Publication
(10) Pub. No.: US 2021/0270514 A1
(43) Pub. Date: Sep. 2, 2021

(54) COLD STORAGE PACK, LOGISTIC PACKAGING CONTAINER, METHOD OF TRANSPORTING OBJECT AT LOW TEMPERATURE, AND METHOD OF MANUFACTURING COLD STORAGE PACK

(71) Applicant: SHARP KABUSHIKI KAISHA, Sakai City, Osaka (JP)

(72) Inventors: MASAKAZU KAMURA, Sakai City, Osaka (JP); KYOHEI SEZUKURI, Sakai City, Osaka (JP); HWISIM HWANG, Sakai City, Osaka (JP); SATORU MOTONAMI, Sakai City, Osaka (JP); YUKA UTSUMI, Sakai City, Osaka (JP)

(21) Appl. No.: 17/256,188

(22) PCT Filed: May 27, 2019
(86) PCT No.: PCT/JP2019/020834

§ 371 Date: Dec. 25, 2020

(30) Foreign Application Priority Data
Jun. 29, 2018 (JP) 2018-125107

(51) Int. Cl. F25D 3/00; F28D 20/02; B65D 81/18

(52) U.S. Cl. CPC F25D 3/00; B65D 81/18; F28D 20/02

(57) ABSTRACT

A cold storage pack, a method of transporting an object at low temperature, and a method of manufacturing the cold storage pack are provided in a film pack of cold storage material. The film pack of cold storage material can be propped up with on a certain side thereof as a bottom, and even when it is propped up, the uniformity of the filling density of the latent heat cold storage material is higher. The cold storage pack includes: an encasing section composed of films facing each other and filled with a latent heat storage material therein; a linear external sealing section attached to a periphery of the encasing section to prevent the latent heat storage material from leaking out; and at least one linear internal sealing section extending inwards of the encasing section and adhering internal upper and lower faces of the encasing section together.

### TECHNICAL FIELD

The present invention relates to cold storage packs, logistic packaging containers, methods of transporting an object at low temperature, and methods of manufacturing a cold storage pack.

The present application claims priority to Japanese Patent Application, Tokugan, No. 2018-125107 filed in Japan on Jun. 29, 2018, which is incorporated herein by reference in its entirety.

### BACKGROUND ART

In cold logistic systems, objects that need to be kept cold are packed in a thermally insulated box during transport to reduce heat exchange with the environment. The thermally insulated box typically contains a cold storage material therein during the transport of the object to maintain the object at a prescribed temperature. The cold storage material containing a latent heat storage material comes in various physical forms including rigid resin materials, such as blow-molded containers, and bags made of a soft packaging film material. For better cold insulation during transport, the cold storage material containing the latent heat storage material in a bag of a packaging film material is brought into direct contact with the object, so that the cold storage material can change shape to lit the object upon phase transition from solid to liquid. This structure reduces heat flowing from the surroundings to the object, thereby achieving well-controlled cold storage at a temperature close to the melting point of the latent heat storage material. Patent Literature 1 discloses a small, flexible, incombustible, and impenetrable multi-layered member with excellent heat resistance. Patent Literature 1 also discloses a bag made of such a multi-layered member. The multi-layered member of Patent Literature 1 includes, for example, an external metal foil having a thickness of at least 4 μm, an intermediate resin layer having a thickness of 5 to 40 μm, an internal metal foil having a thickness of at least 9 μm, and a 2 to 10 g/m² self-extinguishable resin layer. The multi-layered member is used to make bags such as flat bags, solid bags, and stand up bags. A cold storage pack of a film-pack type may be prepared by putting a latent heat storage material in the bag disclosed in Patent Literature 1. The cold storage pack can be placed in direct contact with an object for use in cold transport.

### CITATION LIST

### Patent Literature

Patent Literature 1: Japanese Unexamined Patent Application Publication, Tokukaihei, No. 11-010787

### SUMMARY OF INVENTION

### Technical Problem

If the cold storage pack prepared in accordance with Patent Literature 1 (film-pack type) is to be propped up in view of spatial constraints when frozen, however, the bag needs to be a stand up bag with a sufficient bottom area to stand upright and also with a horizontal cross-section that decreases with height from the bottom. The cold storage pack thus structured does not deform, but the fill density of the latent heat storage material decreases with height on the front of the latent heat storage material. The cold storage pack may not be capable of providing uniform cold insulation on the front thereof, failing to deliver desirable cold insulation performance on parts of the cold insulator. The fill density refers to the weight of the latent heat storage material contained in a volume normal to a unit area of the front of the cold storage pack.

Another physical form of the film-pack type of cold storage pack is a flat bag composed of two stacked films with sealed edges. When the cold storage pack in this physical form is filled with a latent heat storage material and placed with the front of the cold storage pack (in-plane direction of the flat bag) facing down, the latent heat storage material, which is fluid in the liquid state, Res uniformly flat, so that the fill density thereof has increased in-plane uniformity.

In other words, if the cold storage pack is a flat bag containing a latent heat storage material and frozen with the front thereof facing down, the cold storage pack provides uniform cold insulation across the front. A flat bag may therefore be an excellent physical form for a bag of a packaging film material. However, if the cold storage pack is a flat hag containing a latent heat storage material in the liquid state and used upright due to spatial constraints with one of the sides of the cold storage pack serving as a bottom, the bottom may inflate so that the cold storage pack cannot be propped up or the fill density may not be very uniform across the height thereof so that the cold storage pack cannot provide uniform cold insulation.

The present invention, in an aspect thereof, has been made in view of these conventional problems and has an object to provide a cold storage pack, containing a film pack of (latent) cold storage material, that can be propped up on a side thereof and in which the latent cold storage material, when the cold storage pack is propped up, exhibits an improved uniform fill density and to further provide a logistic packaging container, a method of transporting an object in such a cold storage pack, and a method of manufacturing the cold storage pack.

### Solution to Problem

In order to solve the problems, the present invention, in an aspect thereof, is directed to a cold storage pack including: an encasing section composed of films facing each other and containing a latent heat storage material therein; a linear external sealing section attached to a periphery of the encasing section to prevent the latent heat storage material from leaking out; and at least one linear internal sealing section extending inwards of the encasing section and adhering internal upper and lower faces of the encasing section together.

### Advantageous Effects of Invention

The present invention, in an aspect thereof, provides a cold storage pack containing a film pack of (latent) cold storage material that, when the cold storage pack is propped up on a side thereof, exhibits an improved uniform fill density and further provides a logistic packaging container, a method of transporting an object at low temperature, and a method of manufacturing the cold storage pack.

### BRIEF DESCRIPTION OF DRAWINGS

FIG. 1 is a conceptual drawing illustrating a structure of a cold storage pack in accordance with a first embodiment of the present invention.

FIG. 2 is a schematic view of the cold storage pack in accordance with the first embodiment being placed on a plane.

FIG. 3 is a schematic cross-sectional view taken along line III-III′ shown in FIG. 2.

FIG. 4 is a schematic view of the cold storage pack in accordance with the first embodiment being propped up against a wall.

FIG. 5 is a schematic plan view of a bag before a latent heat storage material is injected into the cold storage pack in accordance with the first embodiment (Example 1).

FIG. 6 is a schematic plan view of a bag before a latent heat storage material is injected into the cold storage pack in accordance with the first embodiment (Example 3).

FIG. 7 is a dimension diagram showing dimensions of the cold storage pack in accordance with the first embodiment

FIG. 8 is a schematic view of a cold storage pack in accordance with a second embodiment being placed on a plane.

FIG. 9 is a schematic view of the cold storage pack in accordance with the second embodiment being propped up against a wall.

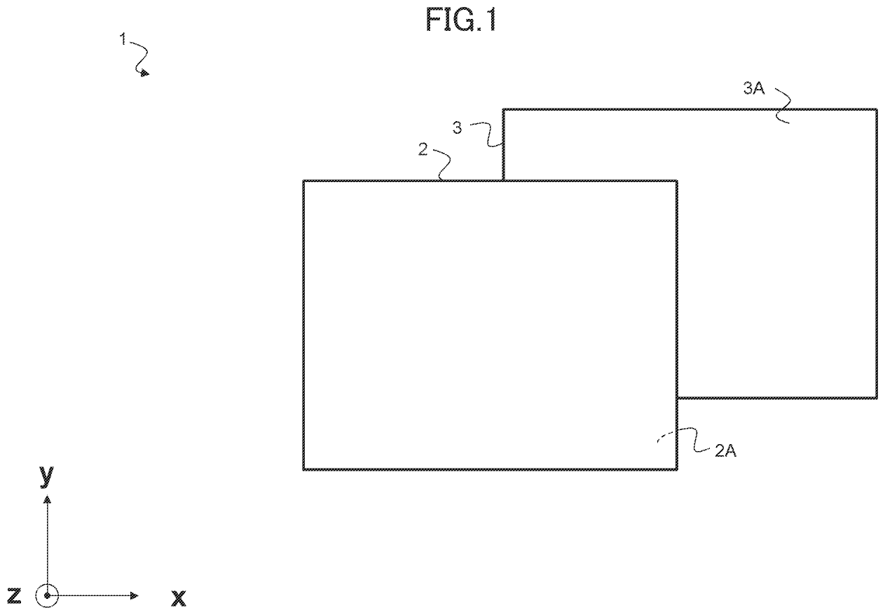

FIG. 1.0 is a diagram illustrating a method of manufacturing the cold storage pack in accordance with the second embodiment.

FIG. 11 is a dimension diagram showing dimensions of the cold storage pack in accordance with the second embodiment.

FIG. 12 is a schematic view of a cold storage pack in accordance with a third embodiment being placed on a plane.

FIG. 13 is a dimension diagram showing dimensions of the cold storage pack in accordance with the third embodiment.

FIG. 14 is a dimension diagram showing dimensions of the cold storage pack in accordance with the third embodiment.

FIG. 15 is a cross-sectional view of a structure of a logistic packaging container in accordance with a fourth embodiment of the present invention.

FIG. 16 is a temperature-characteristics diagram representing temperature changes with time of the logistic packaging container in accordance with the fourth embodiment of the present invention.

FIG. 17 is a conceptual drawing illustrating a structure of a cold storage pack in accordance with a variation example.

### DESCRIPTION OF EMBODIMENTS

The following will describe embodiments of the present invention with reference to drawings. The z-axis in the drawings indicates the thickness direction of the cold storage pack, and the x-axis and the y-axis in the drawings each indicate an in-plane direction of the cold storage pack.

### First Embodiment

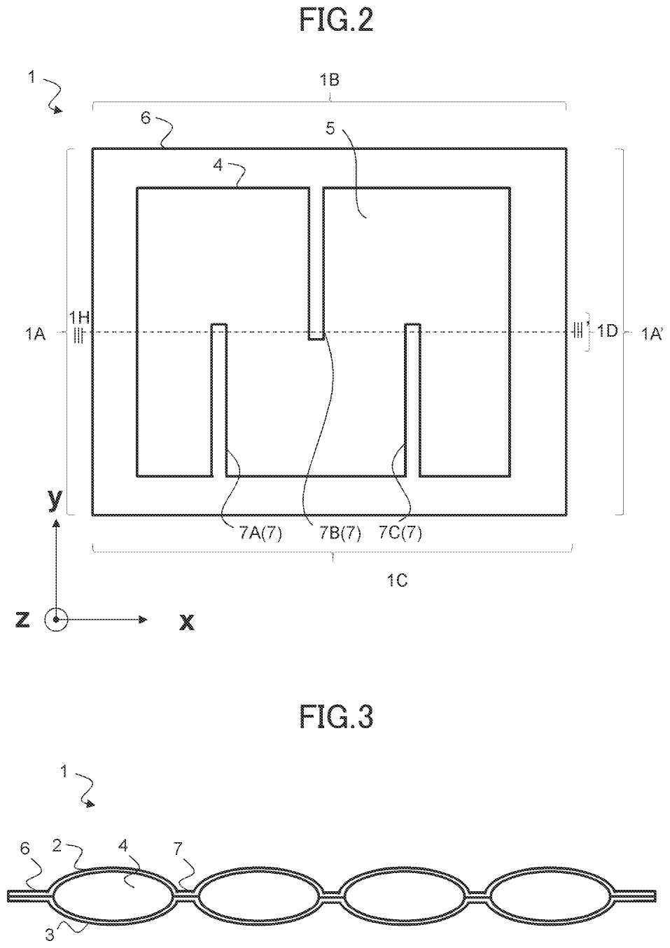

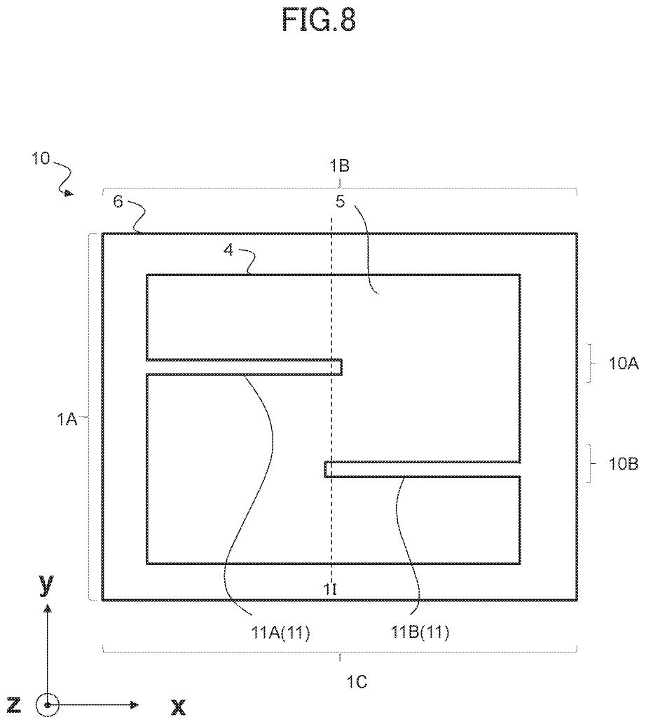

FIGS. 1 and 2 show a cold storage pack 1 in accordance with in the present embodiment. FIG. 3 is a schematic cross-sectional view taken along line III-III′ shown in FIG. 2. Referring to FIG. 1, the cold storage pack 1 includes an encasing section 4 containing a latent heat storage material 5 therein. The encasing section 4 is made of films 2 and 3 facing each other. A linear external sealing section 6 is attached to the periphery of the encasing section 4 to prevent the fluid latent heat storage material 5 from flowing out. The external sealing section 6 is formed by joining parts of the peripheries of the films 2 and 3 together. FIG. 2 shows the cold storage pack 1 being disposed in such a manner that either the film 2 or the film 3 lies on a horizontal plane (x-y plane) (lies on a plane). A similar description applies to FIGS. 8 and 12 introduced later.

The encasing section 4 includes linear internal sealing sections 7 (7A, 7B, and 7C) for attaching an internal top face 2A and an internal bottom face 3A of the encasing section 4 together. The internal sealing sections 7 extend inwards from a pair of opposing sides of the encasing section 4. The internal sealing sections 7 are provided like comb teeth inside the encasing section 4 as described here,

The encasing section 4 is structured like a bag and has a volume of approximately 0.1 L to 10 L in an aspect of the present invention. The volume of the encasing section 4 may however vary with the intended use. The latent heat storage material 5 is produced from a material that provides cold insulation and is fluid in the liquid state.

The latent heat storage material 5 contains a base material that is preferably, for example, a water-based substance, a long-chain hydrocarbon, a carboxylic acid with, for example, a long-chain hydrocarbon, or an alcohol. Among these examples, a water-based substance is particularly preferred in view of the incombustibility thereof and the solvent resistance to the latent heat storage material 5 of, for example, a short-chain-branching, linear low density polyethylene (LLDPE) which may be used to prepare the encasing section 4. Examples of the water-based substance include water, aqueous inorganic salt solutions, and aqueous organic salt solutions. The latent heat storage material 5 may contain additives such as a supercooling inhibitor.

The external sealing section 6 has a width that is preferably larger than or equal to 5 mm and where possible, larger than or equal to 10 mm to ensure a prescribed width and to prevent leakage of the latent heat storage material 5, Meanwhile, an excessively large width increases the volume of the useless parts of the encasing section 4 containing no latent heat storage material 5 or reduces the volume of the parts of the encasing section 4 containing the latent heat storage material 5, thereby degrading the cold insulation capability of the cold storage pack 1, For these reasons, the external sealing section 6 preferably has a width of less than or equal to 30 mm.

More preferably, the width of the external sealing section 6 is from 15 mm to 25 mm, larger than the width of the internal sealing sections 7, and sufficient to externally surround the encasing section 4, in order to increase the stiffness of the external sealing section 6 to such a level that the external sealing section 6 can fully serve as a frame for the encasing section 4 to enable the cold storage pack 1 to be readily propped up against, for example, a wall.

The internal sealing sections 7 have equal lengths and are parallel to a short side 1A (1A′) of the rectangular cold storage pack 1, as shown in, for example, FIG. 2,

The internal sealing sections 7A, 7B, and 7C extend alternately from opposing long sides 1B and 1C of the cold storage pack 1 toward the middle of the short side 1A (1A′) and are separated by equal distances from each other. The internal sealing sections 7A and 7C extend from the long side 1C in a direction perpendicular thereto. The internal sealing section 7B extends from the tong side 1B in a direction perpendicular thereto.

The internal sealing sections 7 have a length greater than half the length of the short side 1A (1A′) of the rectangular cold storage pack 1, The adjacent internal sealing sections 7 alternately intersect with an imaginary line 1H running parallel to the long side 1B (1C) through the midpoints of the short sides 1A and 1A′ and overlap each other near the middle of the short side 1A (1A′). FIG. 3 is a schematic cross-sectional view taken along line III-III′ shown in FIG. 2. Referring to FIG. 3, the encasing section 4 is partitioned, when viewed in a cross-section taken parallel to the x-axis direction, by the adjacent internal sealing sections 7 intersecting with the imaginary line 1H running parallel to a pair of opposing sides of the encasing section 4 through the cold storage pack 1. When the cold storage pack 1 in which the encasing section 4 contains the latent heat storage material 5 in the liquid state is propped up, this structure restrains the flow of the latent heat storage material 5, thereby restricting the inflation of the encasing section 4 caused by the weight of the latent heat storage material 5.

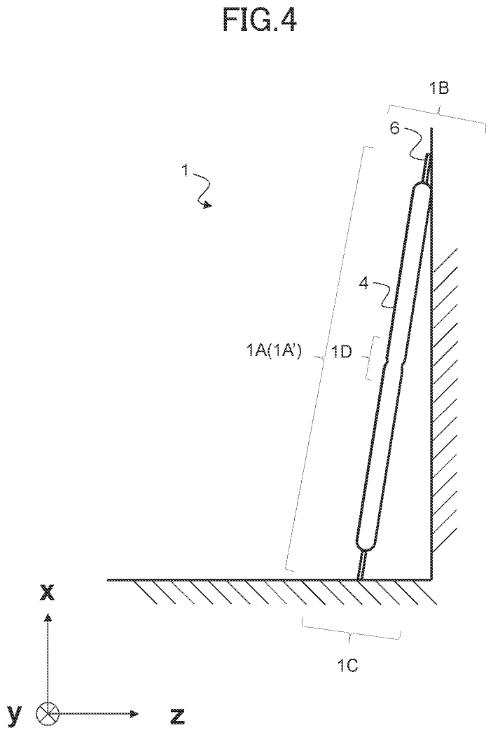

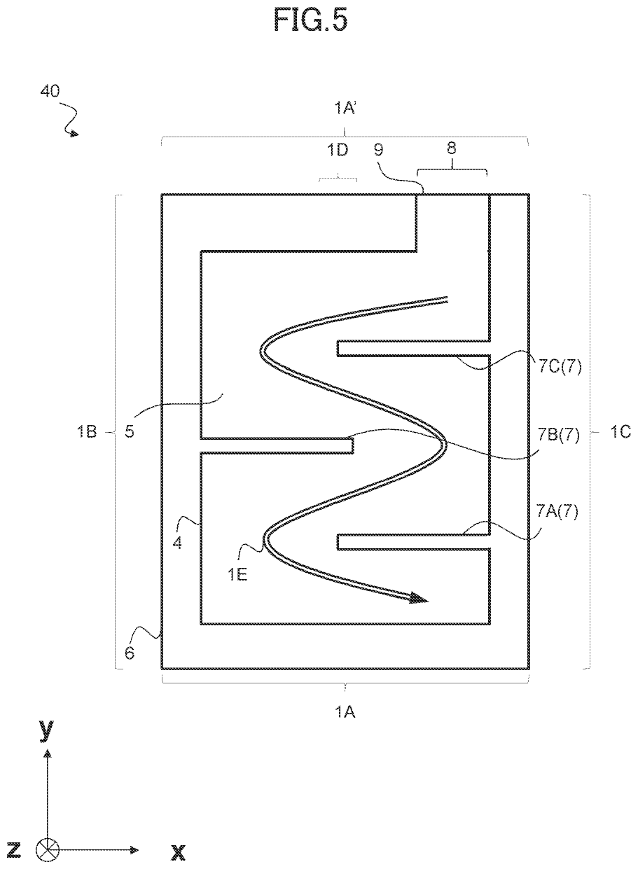

FIG. 4 is a schematic view of the cold storage pack 1 in accordance with the first embodiment being propped up against a wall. The cold storage pack 1, when cooled, is disposed in such a manner that the short side 1A (1A′) faces against the wall and the long side 1C serves as a base, as shown in FIG. 4. In this situation, the latent heat storage material 5 in the liquid state collects in the lower part of the cold storage pack 1. The latent heat storage material 5 freezes with the lower part of the cold storage pack 1 being inflated when compared with the upper part thereof. By attaching the opposing films 2 and 3 together, the internal sealing sections 7 can restrict the inflation of the encasing section 4 caused by the weight of the latent heat storage material 5 in the cold storage pack 1, thereby increasing the in-plane uniformity of the fill density of the latent heat storage material 5 in the encasing section 4.

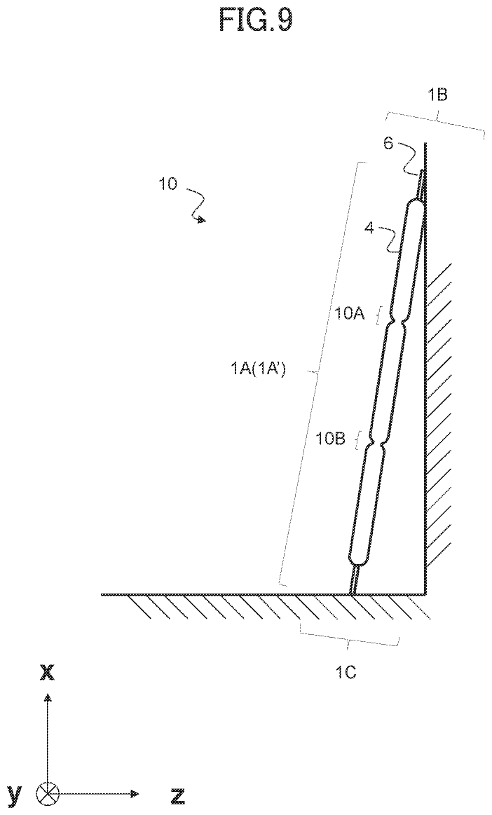

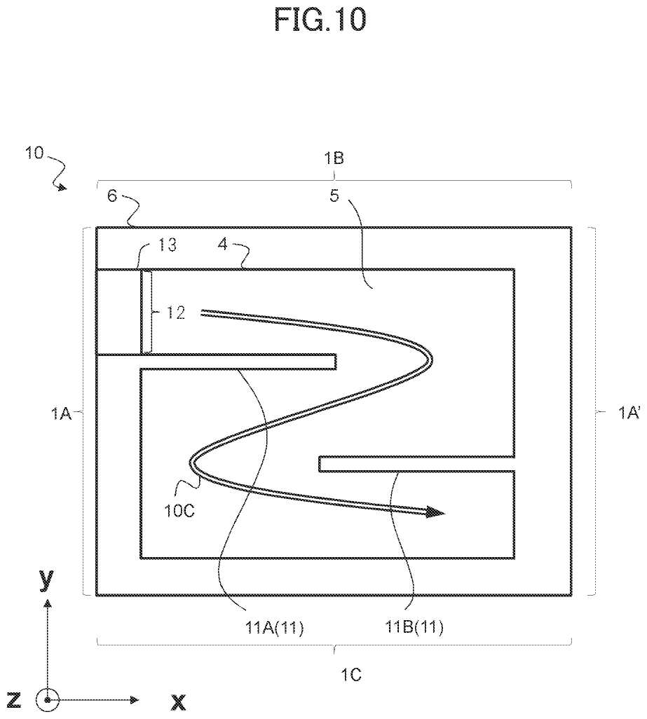

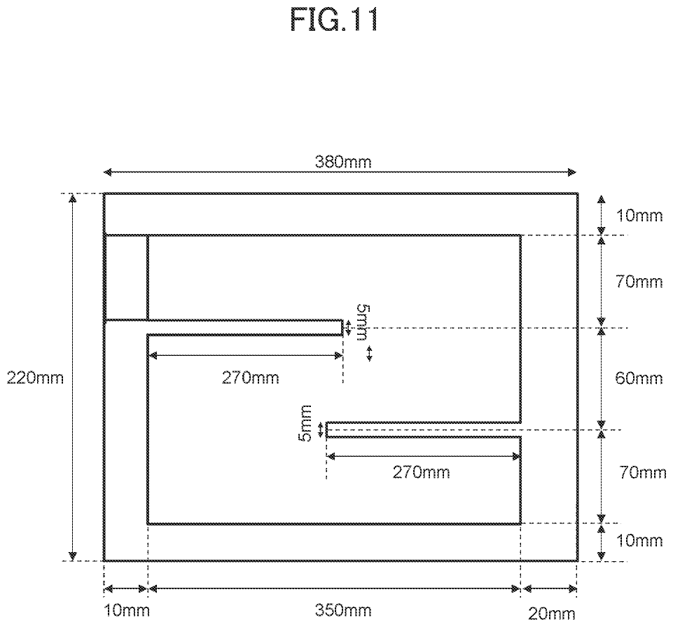

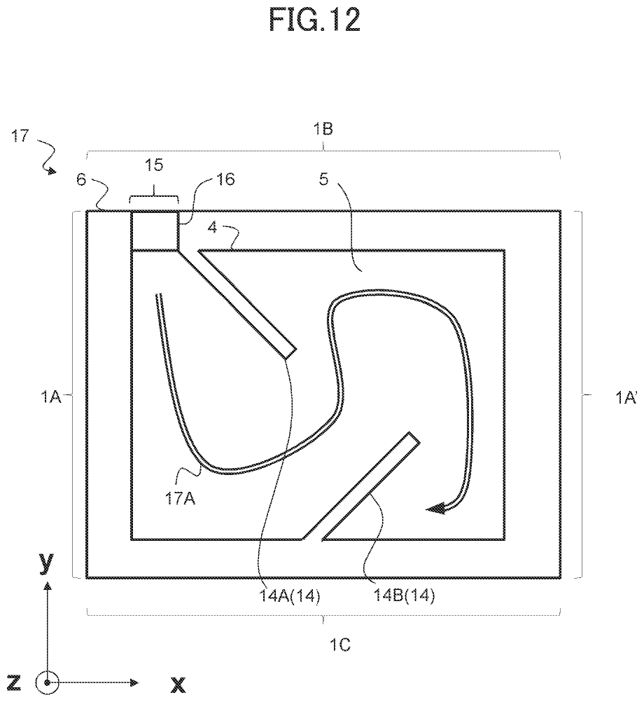

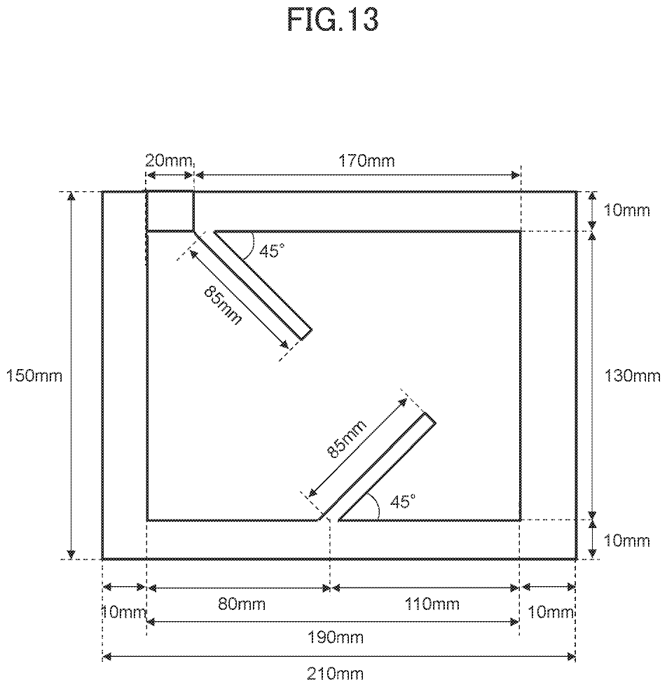

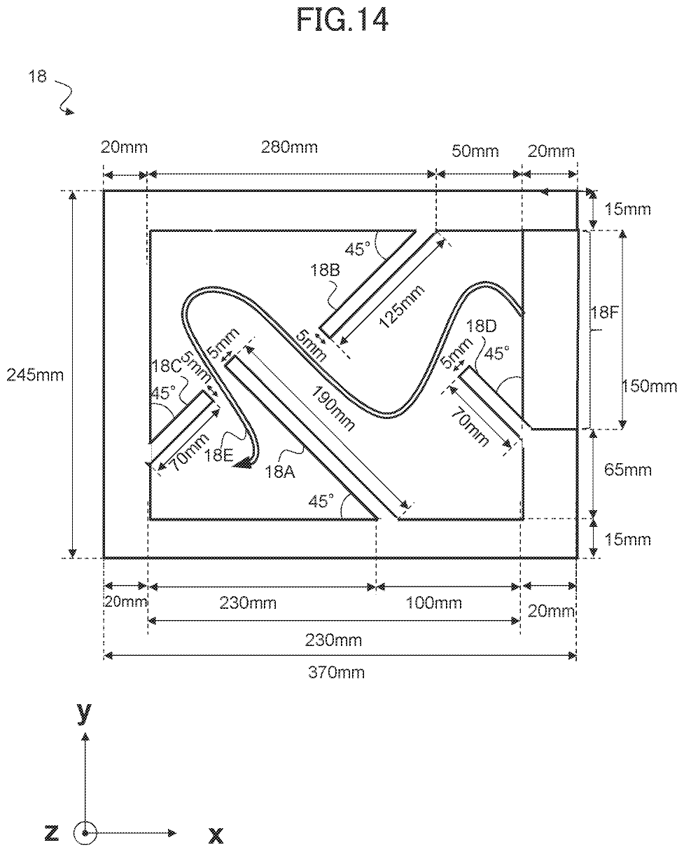

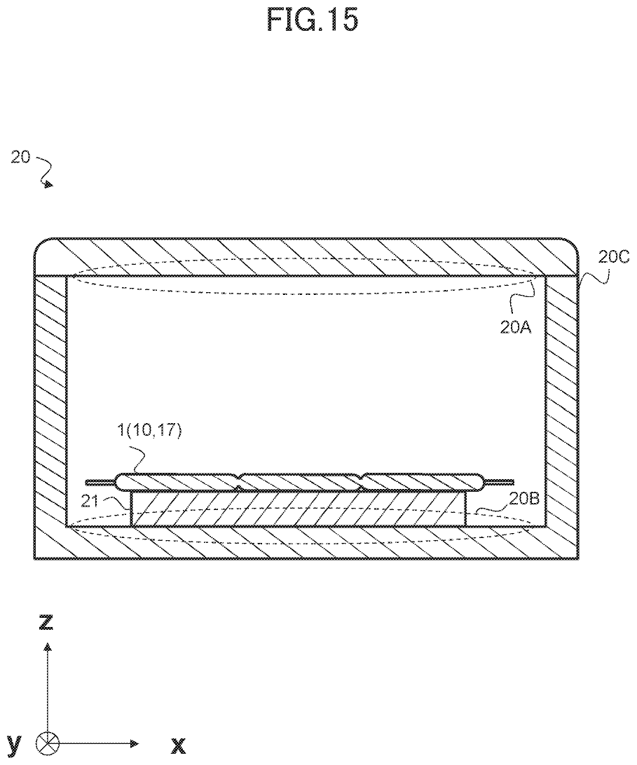

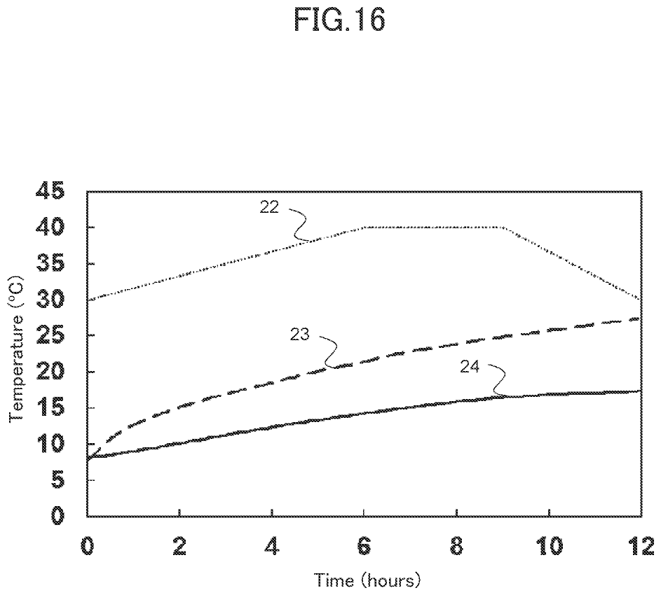

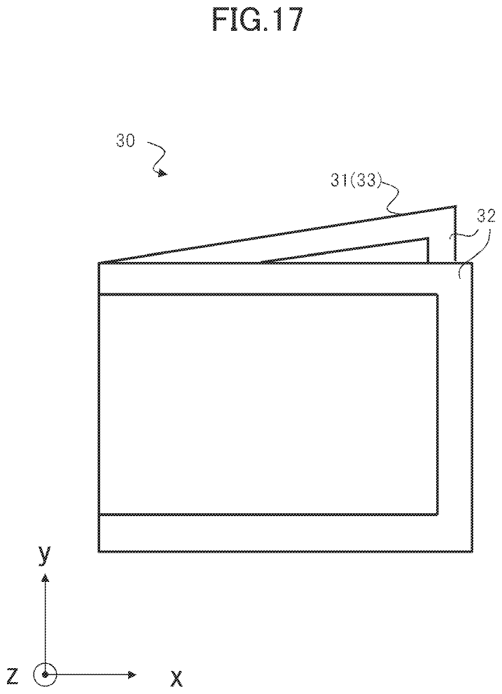

The cold storage pack 1 includes an inflation restricting section 1D for restricting the inflation of the encasing section 4 in a location where those internal sealing sections 7 which are adjacent to each other near the middle of the short side 1A (1A′) reside close to each other. FIG. 4 shows the cold storage pack 1 being disposed in such a manner that one of the sides of the external sealing section 6 lies on a horizontal plane (x-y plane) (propped up against the wall). A similar description applies to FIG. 9 introduced later.

The inflation restricting section 1D better restricts the inflation of the encasing section 4 when those internal sealing sections 7 which are adjacent to each other near the middle of the short side 1A (1A′) overlap more of each other. On the other hand, when those internal sealing sections 7 overlap more of each other, the films 2 and 3 are not easily separable. That restricts the inflation of the encasing section 4, thereby reducing the volume of the latent heat storage material 5 that can be injected into the encasing section 4.

The reduced volume of the latent heat storage material 5 that can be injected into the encasing section 4 reduces cold storage duration time. Adjacent internal sealing sections 7 preferably overlap each other. Alternatively, adjacent internal sealing sections 7 do not necessarily overlap each other and may only be located close to each other.

If the encasing section 4 includes more internal sealing sections 7, the inflation of the encasing section 4 is better restricted, thereby increasing the in-plane uniformity of the fill density of the latent heat storage material 5 in the encasing section 4, On the other hand, when the encasing section 4 includes more internal sealing sections 7, the films 2 and 3 are not easily separable. That restricts the inflation of the encasing section 4, thereby reducing the volume of the latent heat storage material 5 that can be injected into the encasing section 4. The reduced volume of the latent heat storage material 5 reduces cold storage duration time in the cold storage pack 1. The number of internal sealing sections 7 therefore needs to be adjusted in a suitable manner.

The internal sealing sections 7, thus formed, form a flow path 1E (detailed later) for the latent heat storage material 5 inside the encasing section 4. The latent heat storage material 5 can hence be injected more quickly into the encasing section 4, thereby speeding up the manufacture of the cold storage pack 1 and achieving increased productivity in the manufacture of the cold storage pack 1. This flow path is especially effective when the films 2 and 3 have a large thickness, for example, in excess of 100 μm.

The films 2 and 3, when having a thickness in excess of 100 μm, ensures sufficient stiffness of the encasing section 4. If the films 2 and 3 have a thickness in excess of 200 μm, however, it becomes difficult to cover an object 21 to be kept cold (detailed later) with the films 2 and 3, which in turn can reduce flexibility and cold insulation such as cold storage duration time and temperature. The reduced flexibility will render it difficult to fabricate the encasing section 4 into a bag and will reduce the fill amount of the encasing section 4 for the latent heat storage material 5.

The film thickness of the films 2 and 3 is more preferably from 130 μm to 180 μm to ensure the stiffness of the encasing section 4, the cold insulation capability of the cold storage pack 1, and the flexibility of the encasing section 4. The films 2 and 3 of this large thickness increases the stiffness of the encasing section 4, thereby enabling the cold storage pack 1 to be readily propped up against a wall.

The large thickness of the films 2 and 3 meanwhile adds to the weight of the films 2 and 3, increases friction between the films 2 and 3, and increases the stiffness of the films 2 and 3. The films 2 and 3 are therefore not easily separable, so that the latent heat storage material 5 cannot easily enter the encasing section 4 formed by the films 2 and 3.

FIG. 5 is a schematic plan view of a bag 40 before the latent heat storage material 5 of Example 1 (detailed later) is injected into the bag 40. FIG. 5 shows the bag 40 being erected upright. The flow path 1E is provided in the encasing section 4 in the bag 40. The latent heat storage material 5 flows through the flow path 1E when the latent heat storage material 5 is injected. The films 2 and 3 may adhere to each other, rendering it difficult to inject the latent heat storage material 5 into the bag 40. The provision of the flow path 1E for the latent heat storage material 5 inside the bag 40 can render the films 2 and 3 easily separable from each other when the latent heat storage material 5 is injected into the encasing section 4. The flow path 1E for the latent heat storage material 5 may have a width that is large, uniform, and as large as the length of an opening 8 that is an inlet for the latent heat storage material 5, in order to render the films 2 and 3 more easily separable. Such a width of the flow path 1 increases the injection rate of the latent heat storage material 5, allowing the latent heat storage material 5 to easily enter the encasing section 4.

The cold storage pack 1 may include the opening 8 for linking the inside and outside of the encasing section 4 for easy injection of the latent heat storage material 5 in the manufacture process. The flow path 1E is provided in such a manner that the cold storage pack 1 can be erected vertically as shown in FIG. 5, The opening 8 provides one of the ends of the flow path 1E. The flow path 1E forms a single path (“only available flow channel”) from the opening 8 to the other end, so that the latent heat storage material 5 can readily flow through the encasing section 4.

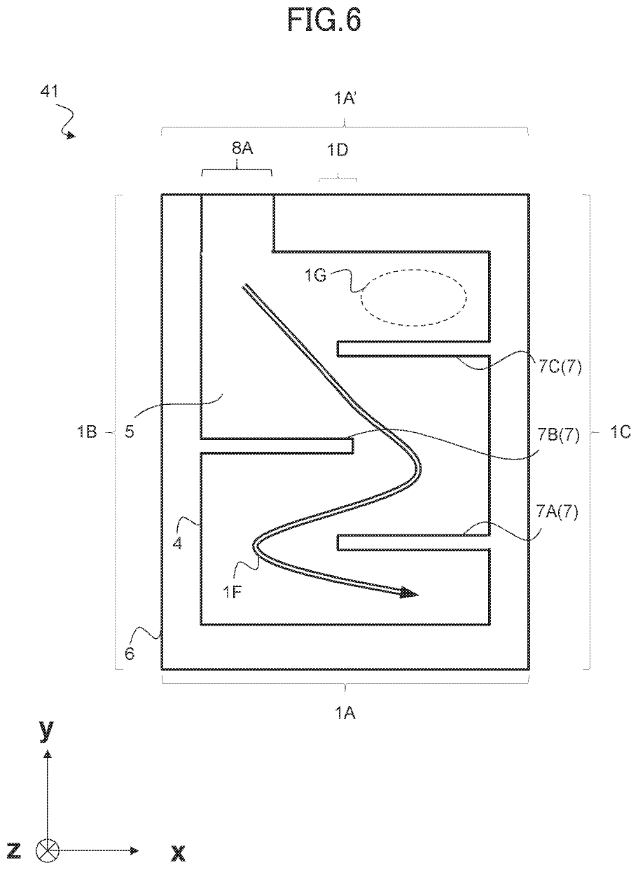

FIG. 6 is a schematic plan view of a bag 41 before the latent heat storage material 5 of Example 3 (detailed later) is injected into the bag 41. The bag 41 has an opening 8A that is an inlet for the latent heat storage material 5. Upon entering the bag 41 via the opening 8A, the latent heat storage material 5 may not follow a flow path 1F (there are more than one available flow channel). The encasing section 4 has therein a segment 1G that cannot be sufficiently injected with the latent heat storage material 5 simply by utilizing the weight thereof. The segment 1G is therefore not sufficiently injected with the latent heat storage material 5. It becomes increasingly difficult to sufficiently inject the latent heat storage material 5 into the segment 1G when the films 2 and 3 have an increased thickness.

As can be understood froth this description, when the flow path 1E provides the only available flow channel, the latent heat storage material 5 reaches each and every corner of the encasing section 4, which in turn increases the volume of the latent heat storage material 5 that can be injected into each bag in the encasing section 4. That can add to the cold storage duration time achieved by every single cold storage pack 1.

When the opening 8 is provided, a sealing portion 9 needs to be provided after the latent heat storage material 5 is injected, to prevent leakage of the latent heat storage material 5. As an example, the sealing portion 9, provided in the step of injecting the latent heat storage material 5, seals the encasing section 4 and is provided in a different step than is the external scaling section 6 attached in the step of preparing the encasing section 4. The sealing portion 9 and the external sealing section 6 have different sealing traces in most situations. A longer opening 8 increasingly facilitates the injection of the latent heat storage material 5, but may increase the likelihood of leaking and difficulty in seating. The opening 8 therefore preferably has a length approximately as large as the width of the flow path 1E.

The films 2 and 3 in the present embodiment are preferably made of a packaging material that can be fabricated by thermocompression (heat sealing), to form the external sealing section 6 and the internal sealing sections 7. Examples of such a material include packaging materials containing at least a short-chain-branching, linear low density polyethylene (LLDPE). The internal sealing sections 7 are formed by adhering together, for example, under heat at or above 110° C., for example, the films 2 and 3 each including a surface layer of LLDPE and disposed in such a manner that the LLPDE layers face each other.

The films 2 and 3 preferably contain LLDPE and a substance, such as nylon (NY), aluminum (Al), or polyethylene terephthalate (PET), laminated or vapor deposited on the LLDPE.

Among these examples, aluminum is preferably used as a constituent of the films 2 and 3 for the purposes of, for example, increasing water vapor transmittance and reducing optical transmittance.

The cold storage pack 1 is manufactured by preparing the latent heat storage material 5, forming a bag from the external sealing section 6 and the encasing section 4 complete with the opening 8 in the external sealing section 6, forming the internal sealing sections 7 inside the encasing section 4, injecting the latent heat storage material 5 via the opening 8, and sealing the opening 8 with the sealing portion 9.

### Example 1

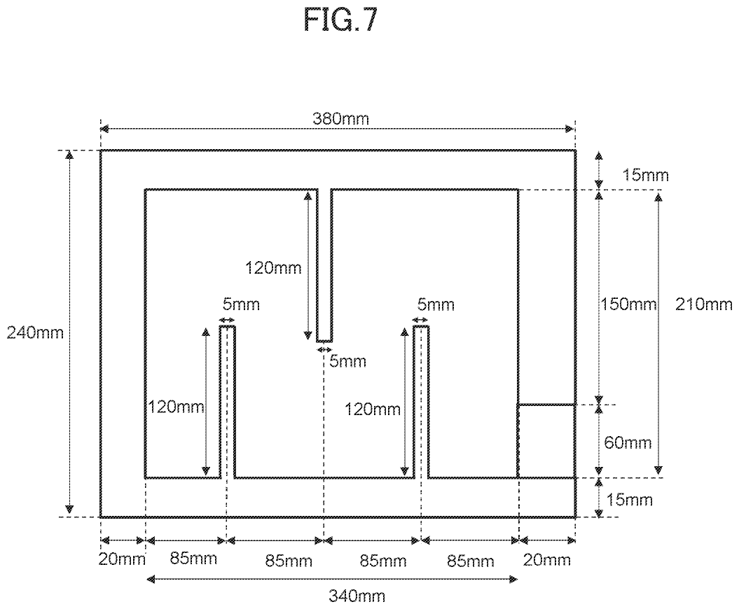

FIG. 7 shows exemplary dimensions as an example of the invention related to the present embodiment. The cold storage pack 1 had an external length of 240 mm along the short side 1A (1A′) and 380 mm along the long side 1B (1C). The opening 8, provided in a part of the short side 1A′, had a length of 60 mm. The external sealing section 6 had a width of 15 mm along the short side 1A (1A′) and 20 mm along the long side 1B (1C). The internal sealing sections 7 had a length of 120 mm and a width of 5 mm and were arranged at equal intervals of 85 mm along the long side 1B (1C). The flow path 1E had a width of 85 mm to 90 mm.

Each film 2 and 3 (packaging film material) had a thickness of approximately 160 μm and was prepared by laminating NY, Al; and LLDPE in this sequence. The films 2 and 3 were disposed such that the LLDPE surfaces faced each other, to form the encasing section 4. The encasing section 4 was adhered by the external sealing section 6 and the internal sealing sections 7.

The films 2 and 3 of the present example had a puncture strength of 30 N according to a JIS standard (JIS Z1707), This value indicates that the films 2 and 3 of the present example had high strength and high stiffness, considering the fact that commercially available detergent and food pouches typically have a puncture strength of approximately 15 N.

The latent heat storage material 5 was prepared by adding a silica gel (particle diameters: 40 to 50 μm, spherical) as a supercooling inhibitor to 1,200 grams of water up to 0.1% and then stirring the resultant mixture to well disperse the silica gel.

The encasing section 4 was injected with the latent heat storage material 5 using an automatic injection device. Water (1,200 mL) was injected into the bag, which was the cold storage pack 1 shown in FIG. 7 yet to be filled with the latent heat storage material 5, at a rate of approximately 40 mL/s through the opening 8. The opening 8 was closed by thermocompression in an impulse sealer after the injection, to form the sealing portion 9.

Visually; the present example hardly deformed when propped up against the wall as shown in FIG. 4.

### Comparative Example 1

The present comparative example differed from Example 1 in that no internal sealing sections 7 were formed in the former. The present comparative example was conducted under otherwise the same conditions as Example 1, In the cold storage pack 1 of the present comparative example, the latent heat storage material 5 collected on the long side 1C shown in FIG. 4, causing a bulge in the bottom potion of the encasing section 4. The cold storage pack 1 deformed much due to the bulge and could not be propped up against the wall.

### Example 2

The present example differed from Example 1 in that the films 2 and 3 (packaging film material) had a thickness of 90 μm and was prepared by laminating NY, PET, and LLDPE in this sequence in the former. The present example was conducted under otherwise the same conditions as Example 1. Although different materials were used between the present example and Example 1 (Al in Example 1 and PET in the present example), these materials were so thin that their stiffness was ignorable. The thickness could be safely regarded as the sole factor that affected the stiffness of the cold storage pack 1.

The films 2 and 3 of the present example had a puncture strength of 15 N according to a IS standard (JIS Z1707). This value indicates that the films 2 and 3 of the present example had a puncture strength equivalent to those of typical, commercially available detergent and food pouches. The cold storage pack 1 of the present example partially deformed, but could be propped up against the wall as shown in FIG. 4. In the cold storage pack 1 of the present example, the latent heat storage material 5 collected on the long side 1C, so that the long side 1B curved and deformed in a gentle concave shape, but could be propped up against the wall as showed in FIG. 4. The deformation was however larger in the present example than in Example 1.

### Example 3

The present example differed from Example 1 in that the former included, as shown in FIG. 6, the opening 8A in a different location from the opening 8 shown in FIG. 5. The present example was conducted under otherwise the same conditions as Example 1. In this structure, the fill amount of the latent heat storage material 5 was 1,000 grams, and the segment 1G, which was located outside the flow path 1F in FIG. 6, was not injected with the latent heat storage material 5. For these reasons, when the cold storage pack 1 was propped up against the wall as shown in FIG. 4, the fill amount of the latent heat storage material 5 was slightly short of filling the latent heat storage material 5 up to the long side 1B (top) thereof. The cold storage pack 1 hence deformed, but could be propped up against the wall.

The volume of the latent heat storage material 5 that was actually able to be injected into the present example was 1,000 mL, which is approximately 80% the volume of the latent heat storage material 5 that was able to be injected into the bag of Example 1 (1,200 mL)

The cold storage pack 1 of the present embodiment can be propped up against the wall even when the latent heat storage material 5 in the cold storage pack 1 is in the liquid state, because the internal sealing sections 7 prevent excessive deformation of the cold storage pack 1, This mechanism allows the cold storage pack 1 to be frozen while being propped up against the wall, which improves ease and efficiency of operation performed by logistics business operators and is therefore preferred.

The cold storage pack 1 of the present embodiment is preferred because the internal sealing sections 7 prevent excessive deformation of the cold storage pack 1, so that the latent cold storage material can maintain the highly uniform fill density thereof.

### Second Embodiment

In the first embodiment, the internal sealing sections 7 (7A, 7B, and 7C) extend inwards from a pair of opposing sides (long sides 1B and 1C) of the encasing section 4. In contrast, a cold storage pack 10 in accordance with the present embodiment includes internal sealing sections 11 (11A, 11B) extending inwards from a pair of opposing sides (short sides 1A and 1A′) of the encasing section 4 as shown in FIG. 8.

The internal sealing sections 11 have a length greater than half the length of the long side 1B (1C) of the rectangular cold storage pack 10. The adjacent internal sealing sections 11 are parallel to the short side 1A (1A′), alternately intersect with a line (1I) running through the midpoints of the long sides 1B and 1C and overlap each other near the middle of the long side 1B (1C).

The first embodiment provides a single inflation restricting section 1D when viewed from the side as shown in FIG. 4, The present embodiment provides the same number of inflation restricting sections 10A and 10B as the internal sealing sections 11 when viewed from the side as shown in FIG. 9.

Similarly to the first embodiment, the present embodiment can restrict the inflation of the encasing section 4 caused by the weight of the latent heat storage material 5 in the cold storage pack 10, thereby increasing the uniformity of the fill density of the latent heat storage material 5 in the encasing section 4.

The present embodiment may provide an opening 12 and a sealing portion 13 as shown in FIG. 10. The provision of the opening 12 forms a flow path 10C for the latent heat storage material 5.

### Example 4

FIG. 11 shows exemplary dimensions as an example of the invention related to the present embodiment. The cold storage pack 10 had an external length of 220 mm along the short side 1A (1A′) and 380 mm along the long side 1B (1C). The opening 8, provided in a part of the short side 1A, had a length of 70 mm.

The external sealing section 6 had a width of 10 mm along the short side 1A, 10 mm on the short side 1A side along the long side 1B (1C), and 20 mm on the short side 1A′ side along the long side 1B (1C). The internal seating sections 11 had a length of 270 mm and a width of 5 mm. The internal sealing sections 11A and 11B were parallel and separated by a distance of 60 mm along the short side 1A (1A′). The internal sealing sections 11 were provided 70 mm from ends of the short sides 1A and 1A′ respectively. The flow path 10C had a width of 60 mm to 70 mm.

Deformation in the present example was visually hardly recognizable and could be regarded as being as small as deformation in Example 1.

### Verification of Effects of Examples 1 to 4

Effects of an aspect of the present invention were verified by way of Examples 1 to 4 and Comparative Example 1. The verification used a front deformation level given by formula (1) that represents a changes in shape of the cold storage packs 1 and 10 that occurs when the cold storage packs 1 and 10 are laid on a plane and a side deformation level given by formula (2) that represents a changes in shape of the cold storage packs 1 and 10 that occurs when the cold storage packs 1 and 10 are propped up against the wall. The verification was done on the latent heat storage material 5 in the liquid state in an aspect of the present invention.

[Math. 1]

Front Deformation Level=(Front Projection Area When Laid on Plane Front Projection Area When Propped Up against Wall)/Front Projection Area When Laid on Plane (1)

[Math. 2]

Side Deformation Level=(Side Projection Area When Laid on Plane−Side Projection Area When Propped Up against Wall)/Side Projection Area When Laid on Plane (2)

The “front” here indicates that the faces of the films 2 and 3 were visible, for example, as in FIG. 2, and the “side” here indicates that the films 2 and 3 were laid down so that the faces thereof were not visible, for example, as in FIG. 3. The projection areas may be calculated from photographs taken from a fixed point located at a certain distance from the cold storage packs 1 and 10 and may alternatively be calculated by comparing the cold storage packs 1 and 10 and a grid on graph paper.

The following is a table showing whether the cold storage packs could be propped up, as well as their front and side deformation levels, in Examples 1 to 4 and Comparative Example 1.

TABLE 1

| | Could Be | Front Deformation | Side Deformation |
|---|---|---|---|
| | Propped Up? | Level | Level |
| Example 1 | Yes | 0.08 | 0.05 |
| Comparative | No | N/A | N/A |
| Example 1 | | | |
| Example 2 | Yes | 0.25 | 0.50 |
| Example 3 | Yes | 0.31 | 0.60 |
| Example 4 | Yes | 0.10 | 0.08 |

Examples 1 and 2 in Table 1 show that the cold storage pack 1 almost hardly deformed when the films 2 and 3 had a thickness in excess of 100 μm if the internal sealing sections 7 were provided. Example 1 and Comparative Example 1 show that if no internal sealing sections 7 were provided, it was impossible to prop up the cold storage pack 1 against the wall and even to compare front deformation levels and side deformation

Examples 1 and 3 in Table 1 show that when an amount of the latent heat storage material 5 was injected that suited the volume of the encasing section 4 (1,200 mL), the encasing section 4 was completely filled with the latent heat storage material 5, thereby exhibiting less deformation.

### Third Embodiment

The first and second embodiments have dealt with the cold storage pack 1 in which the long side (1B, 1C) or the short side (1A, 1A′) is substantially perpendicular to the internal sealing section 7. Alternatively, the long sides 1B and 1C may intersect with internal sealing sections 14 (14A, 14B) at an angle other than the right angles in a cold storage pack 17, as shown in FIG. 12, Referring to FIG. 12, the internal sealing sections 14 (14A, 14B) extend inwards from a pair of opposing sides (short sides 1A and 1A′) of the encasing section 4 in the cold storage pack 17 in accordance with the present embodiment.

When the cold storage pack 17 in accordance with the present embodiment is propped up against the wall on a short side (1A, 1A′) thereof, two inflation restricting sections 10A and 10B are formed as in the second embodiment shown in FIG. 8. Therefore, the present embodiment can restrict the inflation of the encasing section 4 caused by the weight of the latent heat storage material 5 in the cold storage pack 17 similarly to the first and second embodiments, thereby increasing the in-plane uniformity of the fill density of the latent heat storage material 5 in the encasing section 4.

Since the internal sealing sections 14 are provided at an oblique angle in the present embodiment, the internal sealing sections 14 in the present embodiment are longer than the internal sealing sections in the first and second embodiments where the internal sealing sections are provided at right angles. This structure enables the cold storage pack 17 to be readily propped up against the wall.

Furthermore, the internal sealing sections 14 extending in an oblique direction alleviate stress exerted on the internal sealing sections 14 by the latent heat storage material 5 flowing in the liquid state, thereby increasing impact resistance, when force is applied externally to the cold storage pack 17 in the x- and y-axis directions shown in FIG. 12. The cold storage pack 17 hence exhibits increased resistance against drop impact, fir example, in the x- or y-axis direction.

The present embodiment may provide an opening 15 and a sealing portion 16 as shown in FIG. 12. The provision of the opening 15 forms a flow path 17A for the latent heat storage material 5.

Since the internal sealing sections 14 are provided at an oblique angle in the present embodiment, the flow path 17A is wider than the flow paths in the first and second embodiments where the internal sealing sections are provided at right angles. The flow path 17A less frequently has an unnecessarily small width. The wider flow path 17A allows for a higher injection rate of the latent heat storage material 5 and adds to the productivity of the cold storage pack 17.

### Example 5

FIG. 13 shows exemplary dimensions as an example of the invention related to the present embodiment. The cold storage pack 17 had an external length of 150 mm along the short side 1A (1A′) and 210 mm along the long side 1B (1C), The opening 8, provided in a part of the tong side 1B, had a length of 20 mm. The external seating section 6 had a width of 10 mm.

The internal sealing sections 14 (14A, 14B) had a length of 85 mm and a width of 5 mm. The internal sealing section 14A was provided adjacent to the opening 15 on the long side 1B and in such a manner as to make an angle of 45° with the long side 1B. The internal sealing section 14B extended from a point 80 mm from one of the ends of the long side 1C that was located closer to the short side 1A (110 mm from the other end of the long side 1C located closer the short side 1A′) in such a manner as to make an angle of 45° with the long side 1C. The flow path 17A had a width of 30 mm to 120 mm. The amount of the injected latent heat storage material 5 that suited the external dimensions of the cold storage pack 17 in the present example was 200 grams. The width of the flow path 17A in the present example is the distance from the base of a normal to the internal sealing section 14 crossing the flow path 17A to the nearest internal or external sealing section 14 or 6,

### Example 6

FIG. 14 shows exemplary dimensions as an example of the invention related to the present embodiment. A cold storage pack 18 had an external length of 245 mm along the short side 1A (1A′) and 370 mm along the long side 1B (1C). An opening 18F provided in a part of the short side 1A (1A′) had a length of 150 mm. The external scaling section 6 had a width of 15 mm along the short side 1A (1A′) and 20 mm along the long side 1B (1C). Internal sealing sections 18A, 18B, 18C, and 18D had respective lengths of 190 mm, 125 mm, 70 mm, and 70 mm and a common width of 5 mm.

The internal sealing sections 18A and 1813 extended from the long sides 1C and 1B respectively at an angle of 45°. The internal scaling section 18C, D extended from the short sides 1A and 1A′ respectively at an angle of 45°. A flow path 18E had a width of 40 mm to 150 mm. The amount of the injected latent heat storage material 5 that suited the external dimensions of the cold storage pack 18 in the present example was 1,200 grams. The width of the flow path 18E in the present example is the distance from the base of a normal to the internal sealing section 18A or 1813 crossing the flow path 18E to the adjacent internal sealing section 18A or 188 or the external sealing section 6.

### Fourth Embodiment

The first to third embodiments have dealt primarily with the cold storage packs 1, 10, 17, and 18. A logistic packaging container 20 may include the cold storage pack 1 (10, 17, or 18) as shown in FIG. 15.

The logistic packaging container 20 includes a cold storage pack 1 (10, 17, or 18) in a container 20C. The cold storage pack 1 is placed on an object 21, such as fresh produce, to be kept cold. The container 20C has larger internal dimensions than the combined dimensions of the cold storage pack 1 (10, 17, or 18) and the object 21. The container 20C is, for example, a thermally insulating thermal insulation box.

The logistic packaging container 20 directly cools the object 21 therein through thermal conduction by placing the cold storage pack 1 (10, 17, or 18) directly on the object 21.

A conventional, common cold storage pack would be disposed in a top potion 20A and a bottom potion 20B of the container 20C to cool the entire internal space. In contrast, the logistic packaging container 20 in accordance with the present embodiment, when placed directly on the object 21, comes into uniform contact with the object 21, thereby efficiently cooling the object 21, because the cold storage pack 1 (10, 17, or 18) in accordance with the first to third embodiments has a uniform fill density. Heat hardly moves from the object 21 because the bottom of the object 21 is in contact with the bottom potion 20B of the container 20C.

In preparation for the transport of the object 21, the cold storage pack 1 is placed on the object 21. The object 21, together with the cold storage pack 1 placed thereon, is then put into the container 20C which has larger internal dimensions than the combined dimensions of the cold storage pack 1 and the object 21.

### Example 7

The latent heat storage material 5 in the cold storage pack 1 to be placed inside the container 20C was first prepared by adding calcium carbonate (supercooling inhibitor) to a 40 wt % aqueous solution of tetrabutylammonium up to 1% (this latent heat storage material 5 had a density of 1.036 grams at 20° C.). The latent heat storage material 5 had a melting point of 12° C. Example 7 was conducted under otherwise the same conditions as Example 1.

Next, the cold storage pack 1 was propped up against the wall on the long side 1C thereof in a 3° C. cooling container as shown in FIG. 4 and left to sit for 16 hours to freeze the latent heat storage material 5, The front deformation level and the side deformation level were less than or equal to 0.1, indicating that the cold storage pack 1 hardly deformed.

Next, as shown in FIG. 15, the cold storage pack 1 was placed on the object 21 and put into the container 20C, using a robot such as a robot arm. The cold storage pack 1 did not deform and was uniform. The cold storage pack 1 was therefore easy to grab using the robot and did not take unnecessarily much time, for example, in fine-tuning in manipulating the robot to grab the cold storage pack 1.

Next, the logistic packaging container 20 was left to sit in a thermostatic chamber with a temperature-varying function for 12 hours. The internal temperature of the thermostatic chamber was maintained between 30° C. and 40° C. to simulate a midsummer transport environment.

### Comparative Example 2

Three rigid containers (blow-molded containers) were prepared as comparative examples for the present embodiment instead of the cold storage pack 1, Each rigid container was injected with 400 mL of the same latent heat storage material 5 as in Example 7 and was installed so as to cool the interior of the container 20C. The total volume of the latent heat storage material 5 was 1,200 mL as in Example 7. One of the rigid containers was placed in the bottom potion 20B, and the other two were hooked adjacent to each other, for example, onto a lid of the container 20C and placed in the top potion 20A.

### Verification of Effects of Example 7

FIG. 16 is a graph representing changes in the internal temperature of the thermostatic chamber, the temperature of the object 21 of Example 7, and the temperature of the object 21 of Comparative Example 2 over time. A curve 22 represents changes in the internal temperature of the thermostatic chamber over time. A curve 23 represents changes in the temperature of the object 21 of Comparative Example 2 over time, A curve 24 represents changes in the temperature of the object 21 of Example 7 over time.

The curve 23 indicates that the temperature of the object 21 exceeded 15° C. approximately after 2 hours in Comparative Example 2. This is due to the presence of a space between the rigid containers in the top potion and the object 21 in the structure of the rigid container of Comparative Example 2. Heat can hence easily flow into the space from outside the container 20C and raise the temperature.

Meanwhile; the curve 24 indicates that the temperature of the object 21 was maintained at or below 15° C. even after 12 hours in Example 7. This is owing to the decreased space between the object 21 and the cold storage pack 1 as a result of the cold storage pack 1 being placed on the object 21 in the cooling of the object 21 using the cold storage pack 1 in Example 7. The cold storage pack 1, thus placed, cools the object 21 at 12° C., which is a temperature near the melting point of the latent heat storage material 5. Additionally, the cold storage pack 1 in accordance with the present embodiment can keep the object 21 at low temperature when placed on the object 21 because the cold storage pack 1 does not change much in shape when propped up and frozen, and the latent heat storage material 5 has a highly uniform fill density.

### Other Embodiments

The externalsealing section 6 may be provided along the entire periphery of the encasing section 4 to prevent leakage of the latent heat storage material 5. Alternatively, a single film 31 may be folded, and an external sealing section 32 be provided along a part of the periphery of an encasing section 33, as can be understood from HU. 17 showing a cold storage pack 30 (variation example).

The external sealing section 32 may be provided all around the encasing section 33 even when the single film 31 is folded to prevent leakage of the latent heat storage material 5.

The films 2 and 3 in the cold storage packs 1, 10, and 18 have rectangular surfaces. Alternatively, the films 2 and 3 may have, for example, circular or elliptic surfaces in an aspect of the present invention. Additionally, the cold storage packs 1, 10, 17, and 18 are rectangular. Alternatively, the cold storage packs 1, 10, 17, and 18 may have round corners with some radius of curvature. This structure increases safety in handling the cold storage packs 1, 10, 17, and 18.

1. A cold storage pack comprising:
an encasing section composed of films facing each other and filled with a latent heat storage material therein;
a linear external sealing section attached to a periphery of the encasing section to prevent the latent heat storage material from leaking out; and
at least one linear internal sealing section extending inwards of the encasing section and adhering internal upper and lower faces of the encasing section together.

2. The cold storage pack according to claim 1, wherein the films have a thickness of from 100 μm to 200 μm.

3. The cold storage pack according to claim 1, wherein the at least one linear internal sealing section extends inwards of a pair of opposing long sides of the encasing section.

4. The cold storage pack according to claim 1, wherein the latent heat storage material includes, as a base material, water or an aqueous solution of an inorganic salt or an aqueous solution of an organic salt.

5. The cold storage pack according to claim 1, wherein the at least one linear internal sealing section comprises a pair of adjacent linear internal sealing sections extending inwards from a pair of opposing sides of the encasing section respectively and intersecting with a line running parallel to the pair of opposing sides of the encasing section through the cold storage pack.

6. The cold storage pack according to claim 1, wherein
the at least one linear internal sealing section comprises a pair of adjacent linear internal sealing sections extending inwards from a pair of opposing sides of the encasing section respectively and closely located to each other near a middle of the pair of opposing sides of the encasing section, and
a flow path divided for the latent heat storage material by the at least one linear internal sealing section and the external sealing section has a prescribed width.

7. The cold storage pack according to claim 6, further comprising:
an opening in the external sealing section; and
a sealing portion configured to cover the opening, wherein
the sealing portion provides an end of the flow path formed for the latent heat storage material by the at least one linear internal sealing section.

8. The cold storage pack according to claim 1, wherein the external sealing section is provided along the entire periphery of the encasing section and has a greater width than the at least one linear internal sealing section.

9. A logistic packaging container comprising the cold storage pack according to claim 1, wherein
the cold storage pack is placed on an object to cool the object, and
the logistic packaging container is used to contain the object therein.

10. A method of transporting an object at low temperature in a cold storage pack including: an encasing section composed of films facing each other and filled with a latent heat storage material therein; a linear external sealing section attached to a periphery of the encasing section to prevent the latent heat storage material from leaking out; and at least one linear internal sealing section extending inwards of the encasing section and adhering internal upper and lower faces of the encasing section together, the method comprising:
the first step of placing the cold storage pack on the object; and
the second step of putting the object inside.

11. A method of manufacturing a cold storage pack including: an encasing section composed of films facing each other and filled with a latent heat storage material therein; a linear external sealing section attached to a periphery of the encasing section to prevent the latent heat storage material from leaking out; and at least one linear internal sealing section extending inwards of the encasing section and adhering internal upper and lower faces of the encasing section together, the method comprising:
the first step of preparing the latent heat storage material;
the second step of fabricating a bag with an opening in the external sealing section from the external sealing section and the encasing section;
the third step of forming the at least one linear internal sealing section;
the fourth step of injecting the latent heat storage material through the opening; and the fifth step of forming a sealing portion to seal the opening.
